(19) United States
(12) Patent Application Publication
(10) Pub. No.: US 2012/0192039 A1
(43) Pub. Date: Jul. 26, 2012

(54) Method, Apparatuses and Service for Media Transmission

(76) Inventors: Miska Hannuksela, Ruutana (FI); Igor D. Curcio, Tampere (FI); Vinod Kumar Malamal Vadakital, Tampere (FI)

(21) Appl. No.: 13/382,066

(22) PCT Filed: Jul. 3, 2009
(86) PCT No.: PCT/FI09/50614

§ 371 Date: Apr. 6, 2012

(51) Int. Cl. H04L 1/00; G06F 11/14

(52) U.S. Cl. 714/776; 714/746; 714/752; 714/E11.131

(57) ABSTRACT

Methods, devices, computer program products and systems for transmitting and receiving media information are disclosed. The media information is protected against errors introduce by an unreliable channel by error-protection information. The error-protection information is generated, transmitter, received and/or used in rendering based on the context of the receiver, e.g. based on a geographical location of the receiver.

### FIELD OF THE INVENTION

The present invention relates to media transmission, and especially to improving the media transmission over a communication connection where errors in transmission are possible.

### BACKGROUND

Improvements in electronic computing devices, storage technology, data transmission technology, and multimedia compression technology lead to a significant increase in the consumption of digital media by an increasing mass of users. Digital media may be consumed using one or more devices such as a desktop a portable computer, fixed and/or mobile media and music players, smart phones, multimedia computers and/or the like. Media content may also be shared and/or delivered through communication networks. Media streaming, e.g. real time transmission of multimedia content and simultaneously playback at the receiving device(s), is an example media delivery method. Together with other media delivery methods this has increased the demand for devices enabled to show multimedia content to the user regardless of place and time.

There is an increasing demand for devices, systems and/or solutions that offer relatively high media quality, good user experience and/or mobility. Media quality may be affected by different factors among which the quality of the network connection between a transmitting device and a receiving device. In practice, the quality of the network connection between a media server and a user device may be very different depending e.g. on the location of the receiving user device. For example, there may be less-than-perfect segments in the transmission path from the server to the user device. For example, the user device may be a mobile phone equipped with multimedia capabilities, and the user may want to view a piece of video in a location where the radio connection to the user device is poor. Such poor radio connection may be due to human-made obstacles like a building or natural objects like a hill or a dense forest, or it may be merely because so many users are attempting to access the network simultaneously that the available bandwidth per user is limited.

There have been developed methods for improving the error-resiliency of multimedia transmissions. The receiver may, for example, request for retransmissions of data that have been lost or corrupted due to a poor network connection. Another option is to add redundancy to the transmission of the media data by means of e.g. parity information so that the receiver may be able to correct transmission errors in the media data.

### SOME EXAMPLE EMBODIMENTS

Various aspects of the invention include a method, an apparatus, a server, a client and a computer readable medium comprising a computer program stored therein, which are characterized by what is stated in the independent claims. Various embodiments of the invention are disclosed in the dependent claims.

According to a first aspect, there is provided a method for media transmission by an apparatus, comprising electronically generating error-protection information for media stream, electronically arranging the media data to be accessible to another apparatus over a communication interface for a duration, and electronically arranging the error-protection information to be accessible to the other apparatus over a communication interface for a duration longer than the accessibility duration of the media data.

According to an example embodiment, the method further comprises arranging the error-protection information to be accessible to a receiver over a communication interface at least partially earlier than the media data is accessible to a receiver over a communication interface. According to an example embodiment, the method further comprises arranging the error-protection information to be accessible to a receiver over a communication interface at least partially later than the media data is accessible to a receiver over a communication interface. According to an example embodiment, arranging the media data and the error-protection data to be available to a receiver over a communication interface comprises transmitting data. According to an example embodiment, the method further comprises partitioning the media data into a number of partitions, arranging a media data partition to be available to a receiver over a media channel, electronically generating error-protection information for the media data partition, and arranging the error-protection information for the media data partition to be available to a receiver over a channel different from the media channel. According to an example embodiment, the communication interface is an interface to a physical channel or a logical channel.

According to a second aspect, there is provided a method for media reception by an apparatus, comprising electronically determining context information for the apparatus, identifying at least one segment of error-protection information corresponding to media data for accessing by the apparatus based on the context information, and accessing the identified at least one segment of error-protection information corresponding to the media data from a communication interface.

According to an example embodiment, the method further comprises using the accessed at least one segment of error-protection information to help in recovering from an error in the media data. According to an example embodiment, the context information comprises at least one of information on physical position or geographical location, direction of motion, speed, time, reception quality statistics associated with a geographical location and network capabilities at the location of the end-user device. According to an example embodiment, determining the context information comprises receiving context information from at least one of a global positioning system (GPS) transmitter, a geographical information server (GIKS), and a network. According to an example embodiment, the method further comprises identifying media reception quality associated with a location using the context information, predicting a period of time that the apparatus would be in the location, and identifying at least one segment of error-protection information based on the predicted period of time. According to an example embodiment, the method further comprises identifying at least one media data segment sent that has been missed to identify the at least one segment. According to an example embodiment, the method further comprises accessing the error-protection information at least one of at least partially earlier and at least partially later than the corresponding segments of media data are accessible. According to an example embodiment, the method further comprises receiving media data on a media channel, and receiving the error-protection information for the media data partition from a channel different from the media channel. According to an example embodiment, accessing the identified at least one segment of error-protection information comprises identifying a channel. According to an example embodiment, channel comprises one of a physical channel and a logical channel. According to an example embodiment, the method further comprises electronically generating information on the context of the apparatus using at least one of a satellite-based positioning system and a network-based positioning system. According to an example embodiment, the method further comprises rendering the media data to a user, and using the error-protection information to improve the rendering of the media data. According to an example embodiment, the media data have been arranged for transmission according to a broadcasting scheme. According to an example embodiment, the media data have been arranged for transmission according to a data download scheme. According to an example embodiment, the method further comprises the error-protection information is one of the group of forward error correcting information and redundant coding.

According to a third aspect, there is provided an apparatus comprising at least one processor, memory including computer program code, the memory and the computer program code configured to, with the at least one processor, cause the apparatus to perform at least the following: electronically generating error-protection information for media stream, electronically arranging the media data to be accessible to another apparatus over a communication interface for a duration, and electronically arranging the error-protection information to be accessible to the other apparatus over a communication interface for a duration longer than the accessibility duration of the media data.

According to an example embodiment, the apparatus further comprises computer program code configured to, with the at least one processor, cause the apparatus to perform at least the following: arranging the error-protection information to be accessible to a receiver over a communication interface at least partially earlier than the media data is accessible to a receiver over a communication interface. According to an example embodiment, the apparatus further comprises computer program code configured to, with the at least one processor, cause the apparatus to perform at least the following: arranging the error-protection information to be accessible to a receiver over a communication interface at least partially later than the media data is accessible to a receiver over a communication interface. According to an example embodiment, arranging the media data and the error-protection data to be available to a receiver over a communication interface comprises transmitting data. According to an example embodiment, the apparatus further comprises computer program code configured to, with the at least one processor, cause the apparatus to perform at least the following: partitioning the media data into a number of partitions, arranging a media data partition to be available to a receiver over a media channel, electronically generating error-protection information for the media data partition, and arranging the error-protection information for the media data partition to be available to a receiver over a channel different from the media channel. According to an example embodiment, the communication interface is an interface to one of a physical channel and a logical channel. According to an example embodiment, the context information is information on physical position or geographical location.

According to a fourth aspect, there is provided an apparatus comprising at least one processor, memory including computer program code, the memory and the computer program code configured to, with the at least one processor, cause the apparatus to perform at least the following: electronically determining context information for the apparatus, identifying at least one segment of error-protection information corresponding to media data for accessing by the apparatus based on the context information, and accessing the identified at least one segment of error-protection information corresponding to the media data from a communication interface.

According to an example embodiment, the apparatus further comprises computer program code configured to, with the at least one processor, cause the apparatus to perform at least the following: using the accessed at least one segment of error-protection information to help in recovering from an error in the media data. According to an example embodiment, the context information comprises at least one of information on physical position or geographical location, direction of motion, speed, time, reception quality statistics associated with a geographical location and network capabilities at the location of the end-user device. According to an example embodiment, determining the context information comprises receiving context information from at least one of a global positioning system (GPS) transmitter, a geographical information server (GIKS), and a network. According to an example embodiment, the apparatus further comprises computer program code configured to, with the at least one processor, cause the apparatus to perform at least the following: identifying media reception quality associated with a location using the context information, predicting a period of time that the apparatus would be in the location, and identifying at least one segment of error-protection information based on the predicted period of time. According to an example embodiment, the apparatus further comprises computer program code configured to, with the at least one processor, cause the apparatus to perform at least the following: identifying at least one media data segment sent that has been missed to identify the at least one segment. According to an example embodiment, the apparatus further comprises computer program code configured to, with the at least one processor, cause the apparatus to perform at least the following: accessing the error-protection information at least one of at least partially earlier and at least partially later than the corresponding segments of media data are accessible. According to an example embodiment, the apparatus further comprises computer program code configured to, with the at least one processor, cause the apparatus to perform at least the following: receiving media data on a media channel, and receiving the error-protection information for the media data partition from a channel different from the media channel. According to an example embodiment, accessing the identified at least one segment of error-protection information comprises identifying a channel. According to an example embodiment, channel comprises one of a physical channel and a logical channel. According to an example embodiment, the apparatus further comprises computer program code configured to, with the at least one processor, cause the apparatus to perform at least the following: electronically generating information on the context of the apparatus using at least one of a satellite-based positioning system and a network-based positioning system. According to an example embodiment, the apparatus further comprises computer program code configured to, with the at least one processor, cause the apparatus to perform at least the following: rendering the media data to a user, and using the error-protection information to improve the rendering of the media data. According to an example embodiment, the media data have been arranged for transmission according to a broadcasting scheme. According to an example embodiment, the media data have been arranged for transmission according to a data download scheme. According to an example embodiment, the error-protection information is one of the group of forward error correcting information and redundant coding. According to an example embodiment, the apparatus further comprises user interface circuitry for receiving user input, user interface software configured to facilitate user control of at least some functions of the apparatus through use of a display and configured to respond to user inputs, and a display and display circuitry configured to display at least a portion of a user interface of the apparatus, the display and display circuitry configured to facilitate user control of at least some functions of the apparatus.

According to a fifth aspect, there is provided an apparatus comprising means for generating error-protection information for media stream, means for arranging the media data to be accessible to a receiver over a communication interface for a duration, and means for arranging the error-protection information to be accessible to a receiver over a communication interface for a duration longer than the accessibility duration of the media data.

According to a sixth aspect, there is provided an apparatus comprising means for electronically determining context information for the apparatus, means for identifying at least one segment of error-protection information corresponding to media data for accessing by the apparatus based on the context information, and means for accessing the identified at least one segment of error-protection information corresponding to the media data from a communication interface.

According to a seventh aspect, there is provided a computer program product stored on a computer readable medium and executable in a data processing device, wherein the computer program product comprises computer program code sections for performing the method steps according to any of the embodiments of a first and a second aspect of the invention.

### DESCRIPTION OF THE DRAWINGS

In the following, various embodiments of the invention will be described in more detail with reference to the appended drawings, in which

FIG. 1a shows an example communication system for transmitting media data according to at least one example embodiment where context information is employed in error resiliency;

FIG. 1b shows another example communication system for transmitting media data according to at least one example embodiment where context information is employed in error resiliency;

FIG. 2 shows an example block diagram of a broadcasting server and an example block diagram of a user terminal;

FIG. 3 shows a flowchart illustrating a method for media and error correction data transmission at the sender according to an example embodiment where context adaptive error resiliency is used.

FIG. 4 shows a flowchart illustrating a method for employing context adaptive error resiliency at the receiver according to an example embodiment.

FIG. 5 is a diagram showing transmission and reception of media data in an example embodiment where context information is employed in transmitting and/or receiving error-correction information that may be used during a time of poor reception at the receiver;

FIG. 6 is a diagram showing transmission and reception of media data in another example embodiment where context information is employed for transmitting and/or receiving error-correction information that may be used during a time of poor reception at the receiver;

FIG. 7 is a diagram showing transmission and reception of media data in yet another example embodiment where context information is employed for transmitting and/or receiving error-correction information that may be used during a time of poor reception at the receiver;

FIG. 8 is a functional block diagram for a media transmission system where context information is employed for error-resiliency;

### DETAILED DESCRIPTION OF SOME EXAMPLE EMBODIMENTS

In the following, several example embodiments will be described in the context of an apparatus comprising hardware elements and software code executable on a processor that enables the apparatus to transmit and/or receive media data, as well as a network element comprising hardware elements and software code executable on a processor that enables the network element to transmit and/or receive media data, as well as a network connecting two or more of these devices so that they can communicate and access data offered by the different devices. It is to be noted, however, that the invention is not limited to operating on a single device. In fact, the different embodiments have applications widely in any environment where improved media transmission functionalities are needed, for example in an environment where data and/or computer programs are distributed among different devices and data is accessed from these different devices.

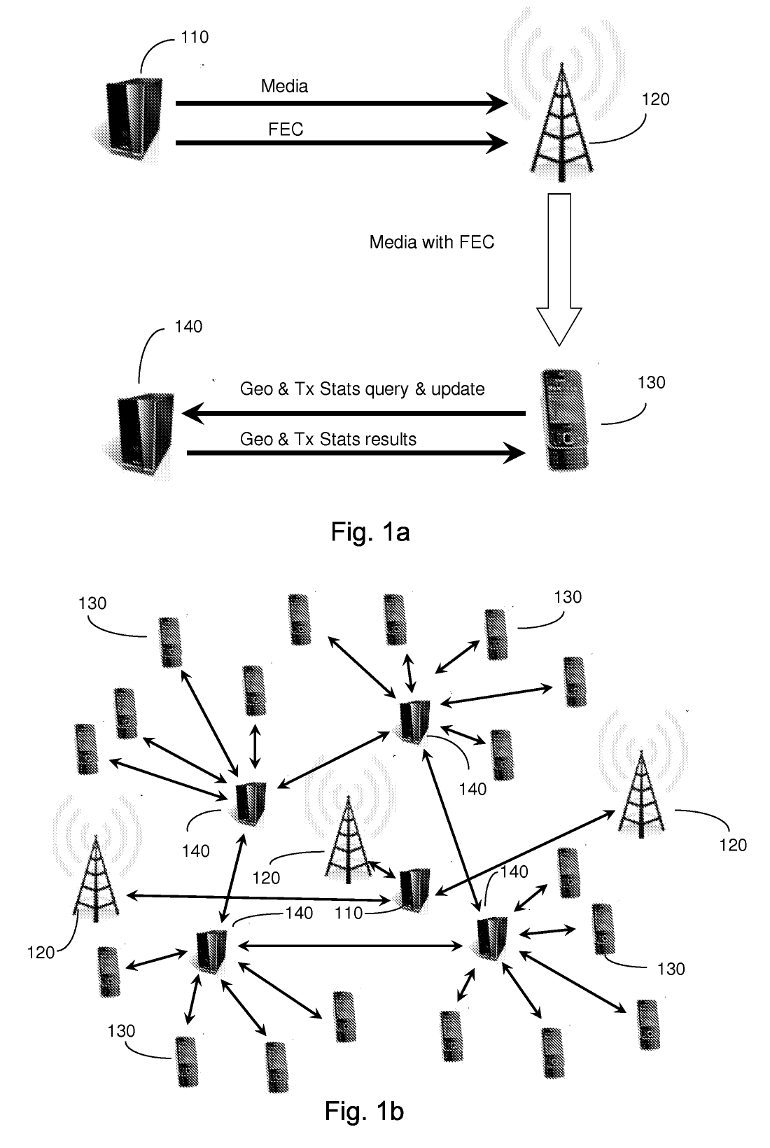

FIG. 1a shows an example communication system for transmitting media data according to at least one example embodiment where context-based error resiliency is employed. A broadcast system comprises a broadcasting, server 110, a user terminal 130 and a communications network coupling the user terminal 130 to the broadcasting server 110. The communications system may further comprise a geo-information knowledge server 140. The communications network comprises a communication node, or transmitter, 120 to transmit broadcast media content to one or more user mobile terminals, or mobile clients. Mobile clients (MC) receive data from the communication node 120, for example, via a radio channel. The communications network comprises one or more networks, for example, a fixed network, a wireless network, the internet, a local area network and/or the like.

The broadcasting server 110 contains in its storage elements or has access to data on external storage elements or devices via a communication interface. The data may be media data such as images, music, video or any combination of these, binary or textual data of another kind like presentations, word processing documents, spreadsheets, or computer programs or other active content that can be run on a computer processor. In this description, for the purpose of simplicity, the sending of media data is described, but it needs to be understood that other data may be sent using similar methods and equipment. The broadcasting may be multicast or unicast, where a stream of media data is sent to multiple receivers or a single receiver, correspondingly.

In an example embodiment, the broadcasting server 110 is a content provider server. In another example embodiment, the broadcasting server 110 is a streaming server, within the communications network, receiving media content from a content provider and broadcasting the received content, over the communications network, to one or more user terminals. Some multimedia content may be scheduled to be broadcast from the broadcasting server 110. The multimedia content may be stored, for example, in the broadcasting server 110, in a separate content server or in a storage coupled to the broadcasting server 110. The multimedia content may also be received, at the broadcasting server 110, from another user terminal coupled to the broadcasting server. Media data and forward error correction (FEC) information are sent, from the broadcasting server 110, to the communication node 120 where the media data and the FEC data are transmitted to one or more user terminals 130. The FEC information may be sent separately from the media data, in connection with the media data, or both.

The different devices may be connected via a fixed network such as the internet or a local area network, or a mobile communication network such as the Global System for Mobile communications (GSM) network, 3^{rd} Generation (3G) network, 3.5^{th} Generation (3.5G) network, 4^{th} Generation (4G) network, Wireless Local Area Network (WLAN), Bluetooth, or another contemporary and future networks. The different networks may be connected to each other by means of a communication interface. The networks may comprise network elements such as routers and switches to handle data (not shown), and communication interfaces such as the base stations in order for providing access for the different devices to the network, and the base stations may themselves be connected to the mobile network via a fixed connection or a wireless connection.

There may be a number of servers connected to the network, e.g. a server for sending media data and connected to the fixed network, a server for storing media data to be sent and connected to either the fixed network or the mobile network and a server for sending media data and connected to the mobile network. There may also be a number of computing devices connected to the networks and/or that are there for storing data and providing access to the data via e.g. a web server interface or data storage interface or such. These devices may be e.g. the computers that make up the internet with the communication elements residing in it.

The user terminal 130 may be equipped with sensors or algorithms that enable it to identify its location. As mentioned earlier, GPS is an example of a method that can be used to identify the location of the user terminal 130. Some user terminals may also be connected to a geo-prediction knowledge server (GPKS) also known as geo-information knowledge server (GIKS) 140. A GIKS server may hold geographical information and associated available bandwidth information. The bandwidth information may be indicative of the network, transmission and/or reception conditions at different geographic locations. The bandwidth information may be made available by the GIKS to other devices via a network interface.

The function of the GIKS or GPKS 140 may be to provide the client, or user terminal 130, with the reception statistics of the current and future probable locations that the user terminal 130 may move into. Alternatively or in addition, the GIKS 140 may provide in the user terminal 130 with information about how much data to be received from the broadcast in order to be able to continue pause-less error-free playback of the multimedia content. The connectivity between the user terminal 130 and the GIKS 140 may be bi-directional. User terminals may be able to upload in their current reception statistics to the GIKS. This may provide input for a constantly learning GIKS. The GIKS 140 may also be connected to the communication nodes 120 and/or the broadcasting server 110 directly in order to provide context information to them for use in forming the error-protection information and/or in sending the error-protection information.

FIG. 1b shows an example system layout with multiple communication nodes 120, user terminals 130, and GIKSs 140 for generating context information that may be used in transmission of media data. In addition to being connected to the communication nodes 120 (connection not shown), the user terminals 130 are connected to their respective GIKSs 140. As described earlier, the connection between the user terminals and the GIKSs may be bi-directional, wherein the GIKSs may provide the user terminals 130 with reception statistics of the current and future probable locations that the user terminal 130 may move into, and the user terminals 130 may be able to upload their current reception statistics to the GIKS. The GIKS 140 may also be connected to the communication nodes 120 and the broadcasting server 110 directly in order to provide context information to them for use in forming the error-protection information and/or in sending the error-protection information. As above, the broadcasting server 110 may be connected to many transmitters or communication nodes 120.

In the process of sending data to the user terminal 130, the media data and error-protection information or forward error correcting (FEC) information may be sent to a communication node (Tx) 120. The communication node 120 may take care of sending the data to the mobile client 130 for example over a wireless or wired connection. The sending of the media data may happen so that the data is partitioned into smaller units for transmission and these units are packaged for transmission e.g. over a wireless connection. At the receiver 130, the packages may be decoded and the data is reassembled from the transmission units. The receiver 130 may also render the data to the user of the receiver e.g. by displaying the visual data on a display and/or playing the audio data through loudspeakers.

The forward error correcting information or other error-protection information may be included in the transmission units, the forward error correcting information may be sent as their own transmission units, or the forward error correcting information may be sent separately from the media data transmission. If the forward error correcting or other error-protection information is sent separately, the sending of the error-protection information may happen on a different channel. The channel may be a physical channel based for example on frequency and/or time division and/or code division, or it may be a logical channel. It is also possible to send a part or none of the forward error correcting information separately, to send a part or none of the forward error correcting information in their own transmission units and to send a part or none of the forward error correcting information inside the media data transmission units. The transmission of the forward error correcting information may happen before sending of the media data, essentially at the same time with the sending of the media data, or after the sending of the media data, or any combination of these. The reception of the forward error correcting information may happen before reception of the media data, essentially at the same time with the reception of the media data, or after the reception of the media data, or any combination of these. An advantage of sending and/or receiving the forward error correcting information before sending and/or receiving the media data may be that the receiver may be able to prepare for a period of poor reception by receiving error-correction information before it is needed. Other error-protection information than forward error correcting information may be transmitted and received for the media data, as well.

A user terminal 130 comprises a mobile phone, a smartphone an internet access device (internet tablet), a personal computer and/or the like. Various user terminals may be connected to communication networks via communication connections such as a fixed connection to the internet, a wireless connection to the internet, a fixed connection to a mobile network, and a wireless connection to a mobile network. The various connections may be implemented by means of communication interfaces.

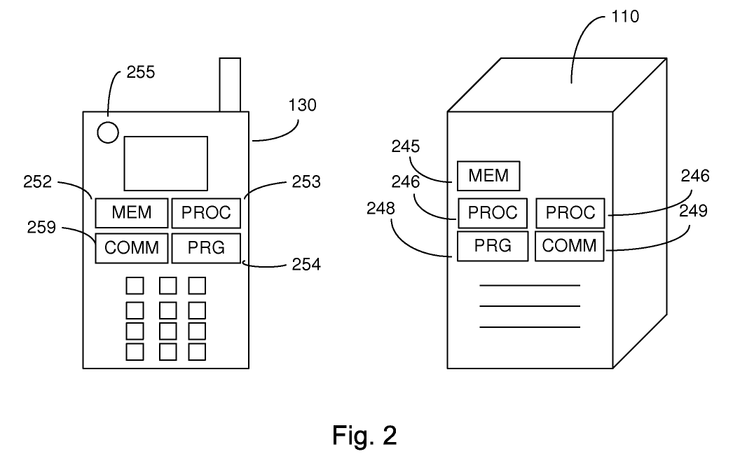

FIG. 2 shows an example block diagram of a broadcasting server 110 and an example block diagram of user terminal 130. The broadcasting server 110 comprises a memory 245, one or more processors 246, computer program code 248 residing in the memory 245 and at least one communications interface 249. The computer program code comprises instructions, when executed by a processor cause the broadcasting server 110 to perform one or more operations associated with embodiments described hereinafter. The broadcasting server 110 exchanges, e.g. sends and/or receives, data with other devices through the at least one communications interface 249.

Similarly, the user terminal 130 comprises memory 252, at least one processor 253, computer program code 254 residing in the memory 252, and at least one communications interface 259. The computer program code comprises instructions, when executed by a processor cause the user terminal 130 to perform one or more operations associated with embodiments described hereinafter. The user terminal 110 exchanges, e.g. sends and/or receives, data with other devices through the at least one communications interface 259. The end-user device may further comprise at least one sensor e.g. camera 255 enabling the capture of media data.

In different embodiments, the sending of media data may happen in various ways, for example using broadcasting. Broadcasting may be understood as point-to-multipoint (p-t-m) transmission of data. Television broadcast may be seen as a template example of broadcasting. The improvements in mobile computing, mobile transmission technology, and multimedia compression technology have enabled broadcasting of multimedia content to mobile handheld devices. The broadcasting may happen in a wired network, in a wireless network or in a combination of these. For example, the broadcasting may happen using radio transmission, or the broadcasting may happen on the internet.

Context may be understood as the environment that a device operates in. Context information comprises the location, direction of movement and/or speed of an end-user device, time, reception quality, for example, of a media service at the end-user device, network capabilities/resources at the location of the end-user device and/or the like. Error resiliency in non-context-sensitive data transmission may be provided e.g. by Automatic Repeat ReQuest (ARQ) method, or by addition of redundancy using Forward Error Correcting (FEC) codes. The varying context in a mobile device operation leads to varying error conditions. Context awareness is made increasingly possible by improvements in hardware technology for mobile devices, for example, mobile devices may be equipped with a variety of sensors that allow mobile devices to be aware of their context.

The process of locating a device by computing the time difference of arrival of a signal originating from three or more time-syncronised transmitters may be called multilateration or hyperbolic positioning. A variety of methods for positioning using multilateration may be used to provide location based information to a device.

One method for positioning is the Global Positioning System (GPS). GPS is a constellation of 24 to 32 medium orbit satellites. The satellites transmit radio wave signals that a GPS receiver can use (up to some error) to identify its location, time and velocity. The collection of the location, time and velocity variables may be called a context vector. The location, L(á, â) of any point on the earth surface is unique and is given by the values of latitude á, and longitude â. Many current mobile devices are equipped with a GPS receiver (GPS sensors) that may be used to determine the location of the device.

Another method for positioning is network-based localization such as GSM localization. Network-based localization works by identifying the location based on the device position with respect to its cell site (the site of the base station that the device is connected to). Many methods of multilateration of the signal from the cell sites to the mobile phone may be used. Network-based localization uses the service provider's network infrastructure to locate the mobile device. The accuracy of locating can vary from simple cell identification that gives the position with the accuracy of the cell size to methods using triangulation that may give more accurate results. Positioning or localization based on wireless local area networks (wireless LANs) may also be used. In positioning based on WLAN, the cell size may be considerably smaller than in the case of GSM and databases of WLAN cell ids may be used to determine the location of the device. The accuracy of multilateration can also vary depending on the concentration of base stations. A hybrid of GSM and GPS multilateration also exists, and may be more accurate or reliable than either of them individually.

Multimedia content, e.g., audio or audio/video files and streams, music files and streams, digital images, and other content files may be delivered from a transmitter/sender/server to a receiver/client in different ways. Digital images and other files may be transferred between server and clients by downloading or uploading, depending on the use case. There are standardized protocols for these methods of transfer to ensure that a complete file is transferred. These down-loading and uploading methods may be used also when multimedia files are transferred. With these methods the file may need to be received completely without errors before the file can be rendered by the receiver, e.g., the client in a downloading use case, and the server in the uploading use case. Another media content delivery method is streaming in which the rendering of content may be started by the receiver before the whole content file has been received, e.g., the rendering may start when the later parts of the same content are still being delivered.

An unreliable transport protocol may be used for streaming in order to achieve a reasonably low end-to-end delay. Consequently, it may not be possible to reproduce the multimedia data perfectly at the receiver due to transmission errors. Streaming delivery may be used, for example, when the end user wants to start consuming the content as soon as possible, when live content is being delivered in real-time and/or downloading of the whole content file before starting the rendering would take too much time. Furthermore, streaming allows the usage of a relatively smaller buffer in the receiving device because only a small portion of the streamed file may be stored in the receiver before it is rendered. Already rendered data may be ignored, e.g., deleted or written over, at the receiver. The Real-time Transport Protocol (RTP) is an example streaming protocol. The RTP Control Protocol (RTCP) provides control and identification functionality and allows monitoring of the data delivery. Both RTP and RTCP have been standardized by the international engineering task force (IETF).

Progressive downloading may be understood to refer to a transmission of a multimedia file over a reliable communication protocol, such as the hypertext transfer protocol HTTP, and decoding/rendering the file while it is being received. While progressive downloading may guarantee essentially perfect reproduction of the transmitted file, the receiver may have to halt the playback for example if the channel throughput falls under the data rate of the file, for example, in unicast transmission. Progressive download over multicast or broadcast delivery has also been considered. The transmitted file may be protected by a FEC scheme to maximize the likelihood of error-free recovery of the file. However, if the transmission error rate exceeds the recovery capability of the applied FEC, the playback of the file being progressively downloaded may be halted until the next correctly recovered file segment is available, or may be stopped altogether until the whole file is recovered based on the received FEC parity data, an interactive recovery procedure has been at least partly carried out over a unicast channel, or a repeated transmission of the file is performed.

In a system employing context-aware error resiliency, a transmitting server usually reacts to the changing context of a client device. Employing context aware error resiliency in broadcast transmission may be difficult for different reasons. First, a large number of clients may be tuned into the broadcast, and it is challenging, for a transmitting server, to keep track of the changing contexts of each client and to react in such a way that can satisfy every client. Second, broadcasting techniques usually use unidirectional transmission mechanisms, which means that there may be no return channel from the client to the transmitting server to notify its reception statistics.

A multimedia broadcast service consumed by a mobile client may be prone to errors as the mobile client moves from one context to another. The reasons for these errors may be due to the radio channel propagation properties, like signal attenuation and multi-path error propagation. There may also be other reasons such as congestion in intermediary network elements that can cause data errors or data loss. Methods for providing error robustness comprise forward error correction (FEC) and automatic repeat request (ARQ). Forward error correction (FEC) codes add redundancies to the transmitted data. When using ARQ messaging, a client device requests the lost data to be retransmitted. However, use of ARQ may not be readily possible in a purely broadcast case because of the unidirectional nature of the broadcast channels. In the case there is a return channel for ARQ, the amount of requests from a large number of clients may cause a request congestion at the server.

Using FEC may require the server to buffer some amount of data to compute the parity data. Buffering may mean that there is some amount of delay involved. The larger the buffering of data, the greater the delay for transmitting the data may be. Furthermore, the code rate of the transmission, which is the ratio of the actual data to the total amount of data along with the parity data, may be fixed for the entire transmission session. FEC may be useful when the error rate does not fluctuate too much during the transmission session. If the error rate goes beyond a threshold, FEC may not be able to correct the errors.

In mobile networks, radio channel conditions may change constantly due to the changing environment of the mobile device. For example, a mobile device consuming a multimedia broadcast may go through a tunnel where the reception may be poor or almost lost. Methods and systems according to various embodiments for introducing context adaptability into the error resiliency methods may bring bandwidth efficiency as well as a more robust data transmission environment to mobile broadcasts.

According to an example embodiment, the future route of a device receiving a broadcast stream may be estimated, for example, based on location, direction of motion and speed information. The transmission error rate of the streamed media content, for the receiving device, may further be estimated based at least in part on the estimated route. In order to allow a receiving device to react pro-actively to an estimated future degradation in media reception quality, e.g. estimated increase in transmission error rate, FEC parity data are broadcast in advance of the corresponding media data. The receiving device may decide to access/receive an amount of broadcast FEC parity data based at least in part on the estimated future transmission error rate. The received FEC parity data is used to recover the corresponding part of the broadcast media data and therefore continuous playback during the may be maintained even during periods of poor media reception quality. In other words, a non-stationary receiver may receive a content item over a wireless broadcast network and forward error correction (FEC) parity symbols may be derived from the content item. At least a part of the FEC parity symbols are transmitted earlier than the part of the content item they are protecting. FEC parity symbols that are transmitted earlier than the corresponding part of content are referred to as pro-active FEC parity.

In an example embodiment, the location of a receiving device is determined and its future locations, e.g. path, is estimated as a function of time. The expected reception quality in the future locations of the receiving device are further estimated based at least in part on estimated future locations and, for example, network recorded statistics of reception quality at the estimated future locations. The receiving device uses the received pro-active FEC parity for the recovery of the corresponding part of the content item. The receiving device may decode and may render the recovered part of the content item. An estimate of the desired amount of pro-active FEC parity to be able to recover the respective part of the content item may be estimated based on, for example, the expected reception quality at the future locations of the receiving device and/or an estimated duration of a degradation in reception quality. The receiving device may receive at least the desired amount of pro-active FEC parity. A broadcasting server makes pro-active FEC parity accessible to a receiving device by broadcasting the pro-active FEC parity earlier than the corresponding content part(s). For example, a broadcasting server may broadcast FEC parity repeatedly for a time duration starting earlier than the broadcast of corresponding media data part(s).

In addition to or instead of FEC, other error protection methods may be used. In video, redundant picture transmission may be one such method. Here, a video frame or parts of a video frame, e.g., a slice, may be coded using the same or different quantization parameters, so that upon the loss of the primary coded picture or slice, the redundant representation may be used to recover the lost picture, possibly at a lower quality. Similarly, redundant frames may also be coded for audio data. Redundant picture insertion may be useful when errors in the transmission channel do not occur in bursts. When transmission errors occur in bursts, the transmitter may be aware of the burst duration in order to transmit the primary and the redundant representation far apart so that the burst error does not destroy both representations.

Multimedia data, due to the encoding methodology and perceptual aspects of human sensory organs, may exhibit a behavior, where the coded data contribute unequally to the overall perception of the multi-media presentation. For example, in video data, due to referencing, a loss of an instantaneous decoding refresh (IDR) picture may result in pictures following it that are directly or indirectly referencing it to be erroneous, even if the data for the following pictures are received correctly. In this sense, the priority for the IDR picture may be high. Similarly, non-reference pictures are not used for predicting other pictures, and hence their loss may not propagate to other pictures. Therefore, the loss of a non-reference picture may affect the presentation quality minimally. Understanding the existence of different classes of priorities in coded data, the data belonging to these priority classes can be coded with code rates that are inversely proportional to the priority i.e. higher priority data are coded with a lower code rate and lower priority data are coded with a higher code rate.

Clients of a media broadcast may have the ability, for example, to join a broadcast session at any point between the start and the end of the broadcast session, while still being able to consume the entire broadcast from the start to the end even when the channel is prone to errors. The concept of context adaptive error resiliency with an a priori knowledge of the channel conditions provided by a server may allow corresponding FEC parity data to be transmitted before the respective part of the media stream, and the receiver may proactively select the number of received multicast groups based on the expected error rate.

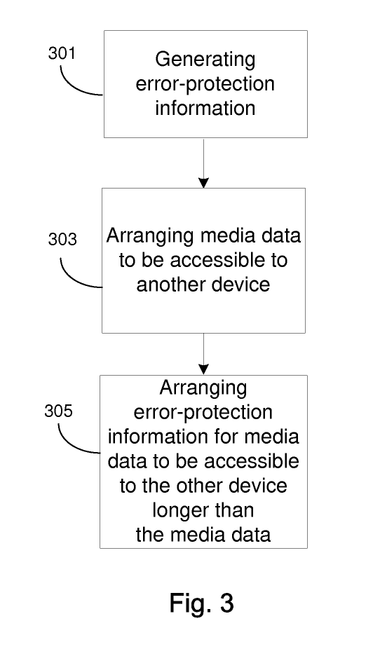

FIG. 3 shows a flowchart illustrating a method for media and error correction data transmission at the sender according to an example embodiment where context adaptive error resiliency is used. In phase 301, error-protection information for the receiver/client may be generated. In phase 305, error-protection information for media data to be used at the client is arranged to be accessible to a receiver, e.g. by transmitting it to the receiver. This arranging of error-protection information to be available may happen prior to arranging the actual media data to be available to the receiver in 303, or prior to the reception or decoding of media data at the client. The error protection information may be arranged to be available longer than the media data. An advantage of sending the error protection prior to the reception of the media data at the client may be that the client may be able to prepare for a predicted poor reception in an upcoming context of the client. Such an optional prediction may also take place at the server and may precede phase 303. If the error-protection information is sent separately from the media data, the sending of the error-protection information may happen on a different channel. The channel may be a physical channel based for example on frequency and/or time division and/or code division, or it may be a logical channel.

In an example embodiment, context data e.g. on the location and speed of the client may be received at the sender side, e.g. at the GIKS. Context information of the receiver may be generated from the context data, for example to form a prediction of the future context of the receiver. Media data may be stored at the sender or at another device that the sender has access to through a communication interface. The storing of media data may happen before or after the forming of the context information.

If context information is determined to be used in generation of the error-protection information, context information may beused in generation of the error-protection information. The use of context information in generation of the error-protection information may happen e.g. so that different error-protection information or different type of error-protection information is generated based on the future prediction of the context of the receiver. Error-protection information may also be generated without the use of context information. If context information is determined to be used in transmission of the error-protection information, context information may be used in transmission of the error-protection information. The use of context information in transmission of the error-protection information may happen e.g. so that different error-protection information or different type of error-protection information is transmitted based on the future prediction of the context of the receiver, or the error-protection information is transmitted at a time depending on the future prediction of the context of the receiver. Error-protection information may be transmitted without the use of context information.Sending of media data may happen before, after or at the same time with sending of the error-protection information.

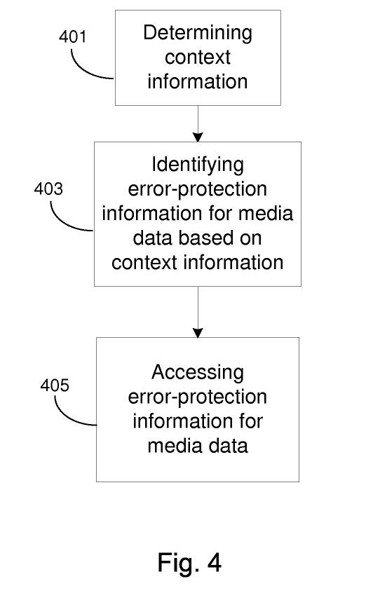

FIG. 4 shows a flowchart illustrating a method for employing context adaptive error resiliency at the receiver according to an example embodiment. In phase 401, context information may be determined. This generation of context information may happen in various ways, e.g. by receiving the information from the server, by performing network-based positioning or by performing satellite-based positioning or any combination of these. In phase 403, error-protection information to be accessed may be identified based on the context information. The identification of the error-protection information may happen for example so that when it is predicted that the receiver will enter a context where reception is poor, the receiver identifies error-correction information prior to entering the context with poor reception for the media partitions that would be received during the poor connection. This may help the receiver to recover from reception errors of the media data that may happen during the time of poor reception. If the error-protection information is sent separately from the media data, the receiving of the error protection information may happen on a different channel. The channel may be a physical channel based for example on frequency and/or time division and/or code division, or it may be a logical channel. In phase 405, the identified error-protection information may be accessed. The error-protection information may then be applied to the media data to correct errors or deficiencies in reception of the media data. There may be a decoding phase where media data is decoded and a rendering phase where the media data is rendered to the user e.g. using a display and/or loudspeakers.

Context data e.g. on the location and speed may be generated at the receiver side, e.g. by a GPS module of the receiver. Context information of the receiver may be generated from the context data, for example to form a prediction of the future context of the receiver. This generation of the context information may happen at the side of the receiver in whole or in part. Alternatively, generation of the context information may happen at the side of the sender, and the context information at the side of the receiver is generated from the context information formed at the sender. Context information may also be transmitted to the sender.

If context information is determined to be used in reception of error-protection information, the receiver may receive error-protection information based on context information. For example, the receiver may predict a time of poor reception based on the context information and may determine to receive error-protection information in advance for the time of the poor reception. The receiver may receive error-protection information without using context information. If context information is determined to be used in applying of error-protection information to the media data, the receiver may apply error-protection information based on context information to the media data. For example, the receiver may have a prediction of a time of poor reception based on the context information and may determine to use error-protection information for data received during the time of the predicted poor reception. The receiver may apply error-protection information without using context information. The media data that may have been decoded using error-protection information may be rendered to the user.

The media, M, that is scheduled to be broadcast, may be segmented into n partitions, M=[m(1)*m(2)*m(3)* . . . *m(n)], which may but need not be equal-sized. The ‘*’ symbol here denotes a concatenation operator. The physical radio channel, C, may also be partitioned into (n+1) logical sub channels, C={c(0), c(1), c(2), . . . , c(n)}. For each partition, m(i) in M, where i denotes the ith partition, FEC parity data, p(i), may be computed. The computed parity bytes may form another parallel bit stream, P=[p(1)*p(2)*p(3)*. . . *p(n)], where p(i) is the parity data for m(i), for all i between 1 to n. Each parity data partition, p(i), may then be transmitted in the logical channel c(i), while the media, M, may be transmitted in channel c(0). The transmission of FEC partitions in the allocated sub channels may be dependent on which scenario the BCS targets. Two example scenarios and their respective transmission methodologies are now presented.

### Context Adaptive Error Resilient Broadcast Media Streaming

A context adaptive broadcast streaming may have some or all of the following three properties or advantages: 1) A client may tune into a broadcast session at any time during the broadcast. The client may consume the media data that is broadcast after tune-in. 2) A client that predicts transmission disruptions in the future may be able to pre-buffer those parity data that help it to recover at least some of the projected lost data. 3) Pre-buffering of the parity data and the consumption of the media stream may require a small buffer space at the client, while the client may still be able to consume the media data without disruption.

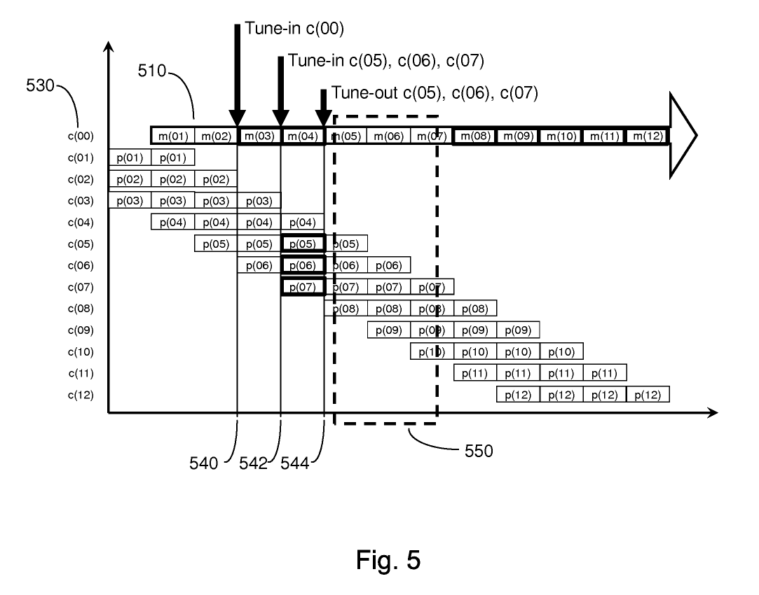

FIG. 5 illustrates an example mechanism to partition the media data 510 and the transmission method to transmit FEC over logical channels. The error-protection or parity data, p(i), may be sent on the channel c(i) 530, only until the time when the related media partition m(i) ends or begins. The error-protection or parity data p(i) may be sent repeatedly as illustrated in FIG. 5, or it may be a non-repeated sequence of data. The error-protection or parity data p(i) may be sent continuously or non-continuously in a time-division-multiplexed manner. The error-protection or parity data p(i) may be sent earlier than the media partition m(i) begins, and there may even be a time interval between the end of the error-protection or parity data p(i) and the beginning of the the media partition m(i). If a client tunes in to channel at some time during the broadcast of the media partition m(k), where 1≦k≦n, the client may be able to playback the media contents starting from the partition m(k) and might not be able to play back a media partition that is transmitted before m(k). In FIG. 5, the client tunes in to channel c(00), the media stream 510, at a time 540. After tuning into the broadcast, the client may be querying the GIKS for statistics of the transmission conditions in the future along the client's path. When the client detects any indication of a transmission reception disruption 550 in the future, it tunes into those channels that carry the error-protection data for those partitions that are predicted to be error prone. In FIG. 5, the error-protection data p(05), p(06) and p(07) for segments m(05), m(06) and m(07) is being transmitted on channels c(05), c(06) and c(07), respectively, and the client may tune into those channels at a time 542. After receiving the error-protection or parity data, the client may tune out from channels c(05), c(06) and c(07) at a time 544.

The media M may be partitioned into 12 partitions and the physical channel C into 13 logical channels. The actual media M may be broadcast in sub-channel c(00). The FEC data p(i) of a media partition m(i) may be transmitted repeatedly in the channel c(i). However, in this streaming case, the FEC data may become useless after the time when the actual media partition arrives. Therefore, the FEC data in any channel c(i) may be repeatedly sent only until the time the actual media data m(i) is sent. After tune-in into sub-channel c(00), the client or receiver may start receiving the data of the next whole media partition that arrives. In this example, the next media partition is m(03). While the client/receiver receives and decodes the data in sub-channel c(00), it may query the GIKS for the statistics of the transmission conditions in the future. If the client detects that there may be a transmission disruption, which in this example is during the transmission of media data m(05), m(06) and m(07), it may also tune in to those sub-channels that carry the parity data for the media partitions that are predicted to be lost. If the client successfully collects all parity data relevant to reconstructing the media partitions that is predicted to be lost the client may decode and play back the media partitions.

The channel bandwidth allocation of logical channel c(00) to c(n) may be done so that the total maximum physical channel bandwidth is minimized, while still being able to pre-buffer parity data so as to recover from future errors with a certain probability. For example, if it is known that the maximum number of segments that may be lost in the entire broadcast transmission is known to be 2, the maximum physical bandwidth needed to recover 2 future lost segments is 4 or a little bit greater than 4 time the media bandwidth. These figures are examples based on the example transmission scenario described in FIG. 5. Let the media transmission use a bandwidth b. If the maximum burst duration causes a loss of n media segments, in order to recover the last media segment the FEC media bandwidth may need to be at least (n+1)b, in the example. Therefore the total transmission for the entire media broadcast session may be (n+1)b+b. Taking the example of two segment losses n=2, the media bandwidth for the broadcast session may be (2+1)b+b=4b. Practical implementations like raptor codes may require more than 4b to be able to reconstruct the lost data.

### Context Adaptive Error Resilient Broadcast Media Download

A context adaptive broadcast download may have some or all of the following three properties or advantages: 1) A client may tune into a broadcast session at any time during the broadcast. The client may anyway be able to consume the entire broadcast media from the beginning to the end. 2) A client that predicts transmission disruptions in the future may be able to pre-buffer those parts of the data that should arrive during the transmission disruptions beforehand, so that the effect of the transmission disruption may be lower to get a better quality of service. 3) The downloaded file may be progressively played out while it is being received.

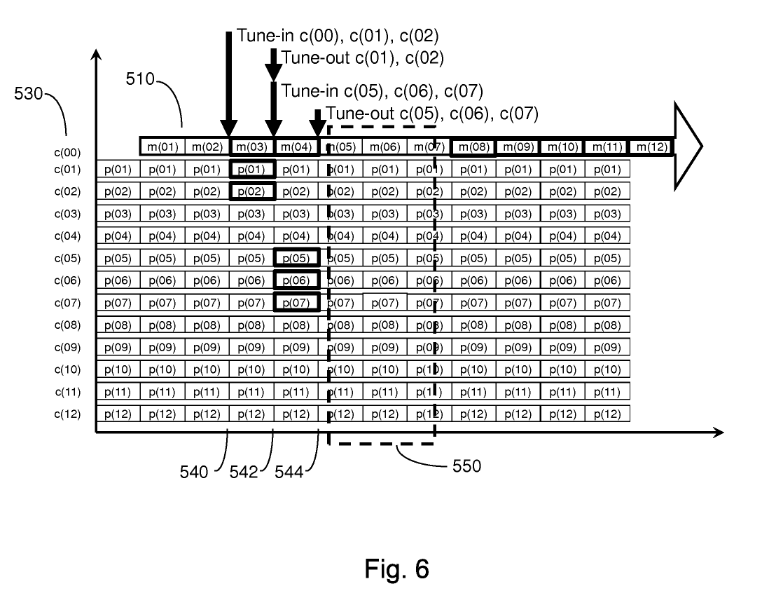

FIG. 6 illustrates one method of transmission of media partitions and their associated parity data or error-protection data. Assume that the media data M 510 to be broadcasted needs a constant bandwidth b. Here, the error-protection or parity data p(i) that is the parity data for the media partition m(i) may be repeatedly sent in the logical channel c(i) 530. The error-protection or parity data p(i) may be sent earlier than the media partition m(i) begins, and there may even be a time interval between the end of the error-protection or parity data p(i) and the beginning of the media partition m(i). If the size of the error-protection or parity data p(i) needed to fully reconstruct the media partition m(i) is the same as the size of m(i) (as in the case of ideal Fountain codes) the sufficient bandwidth needed to transmit p(i) for the same duration as m(i) may be b. The client may tune in at a time 540 during the broadcast, where the next partition of the media data is m(k):1<k<n.

The client may proceed to collect and store all data from channels {c(0), c(1), c(2), . . . , c(k−1)}, for example from channels c(01) 520 and c(02) 522 as shown in FIG. 6. When all the entire partitions of parity data p(1) to p(k−1) are collected in the client's buffer without errors, playback may start. The total bandwidth B that may be required for the media M and the parity data P is B=b(n+1), where n is the total number of media partitions.

Apart from the flexible tune-in time provided by this type of broadcast system, the client, after tuning into the broadcast, may also constantly query the GPKS or GIKS for statistics of the transmission conditions in the future along the client's path. When the statistics from the GIKS predict that there is going to be transmission disruption 550 in the future, the client may automatically tune into those channels that carry the parity data for the partitions of data that are predicted to be erroneous. In FIG. 6, the error-protection data p(05), p(06) and p(07) for segments m(05), m(06) and m(07) is being transmitted on channels c(05), c(06) and c(07), respectively, and the client tunes into those channels at a time 542. After receiving the error-protection or parity data, the client may tune out from channels c(05), c(06) and c(07) at a time 544. This type of broadcasting may be called a Type-0 broadcast scheme.

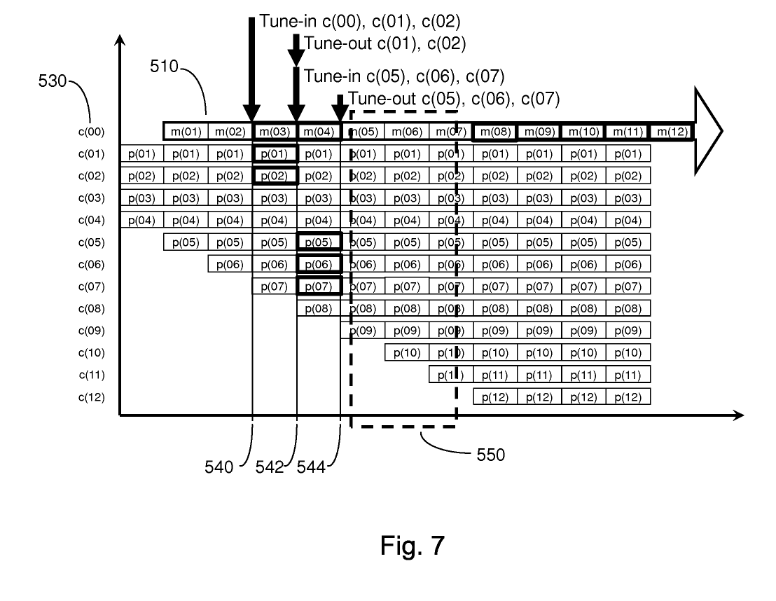

The partitioning of media data and the logical channel splitting are shown in FIGS. 6 and 7. Let M=[m(01)*m(02)* . . . *m(12)] be the media

M portioned into n partitions. Let the physical channel C be also partitioned into n logical channels, C={c(00), c(01), c(02), . . . , c(12)}, the sub-channels being broadcasted with bandwidths, B={b(0), b(1), b(2), . . . , b(12)}. The broadcast server may broadcast the actual media data in channel c(00). Channel c(01) may repeatedly broadcast FEC data of the media partition m(01). Channel c(02) may repeatedly broadcast FEC data of the media partition m(02), and so on. A client may tune into the broadcast during the broadcast transmission. In this example, the tune-in is at the beginning of the transmission of partition m(03) in channel c(00). The client may detect that the next partition that will receive is m(03). It may tune into the channel c(00) to receive the next media partition m(03). It may also tune into the channels c(01) and c(02) to reconstruct the partitions m(01) and m(02). During the reception of data from these channels, the client may also query the GIKS to find when the next transmission disruption may occur. From querying, the client may find that segments m(05), m(06) and m(07) may be lost due to transmission disruptions. The client may therefore tune into the channels c(05), c(06) and c(07) to obtain the FEC data that may help to reconstruct the partitions m(05), m(06) and m(07). The client may tune out of a channel when the whole partition from the channel is received.

FIG. 7 displays an alternative arrangement to the Type-0 broadcast scheme. In the Type-0 broadcast scheme, it may be seen that at every partition interval, error-protection or parity data p(i), for media partitions m(i) 510, are sent in their respective channels c(i) 530. The error-protection or parity data p(i) may be sent earlier than the media partition m(i) begins, and there may even be a time interval between the end of the error-protection or parity data p(i) and the beginning of the media partition m(i). For example, to conserve the total bandwidth, at any partition interval k, only parity data p(1) to p(k+m) may be transmitted in their respective channels, where k<m<n. Again, the client, after tuning into the broadcast at a time 540, may also constantly query the GPKS or GIKS for statistics of the transmission conditions in the future along the client's path. When the statistics from the GIKS predict that there is going to be transmission disruption 550 in the future, the client may automatically tune into those channels that carry the parity data for the partitions of data that are predicted to be erroneous. In FIG. 7, the error-protection data p(05), p(06) and p(07) for segments m(05), m(06) and m(07) is being transmitted on channels c(05), c(06) and c(07), respectively, and the client tunes into those channels at a time 542. After receiving the error-protection or parity data, the client may tune out from channels c(05), c(06) and c(07) at a time 544. This type of broadcast scheme may be called a Type-1 broadcast scheme.

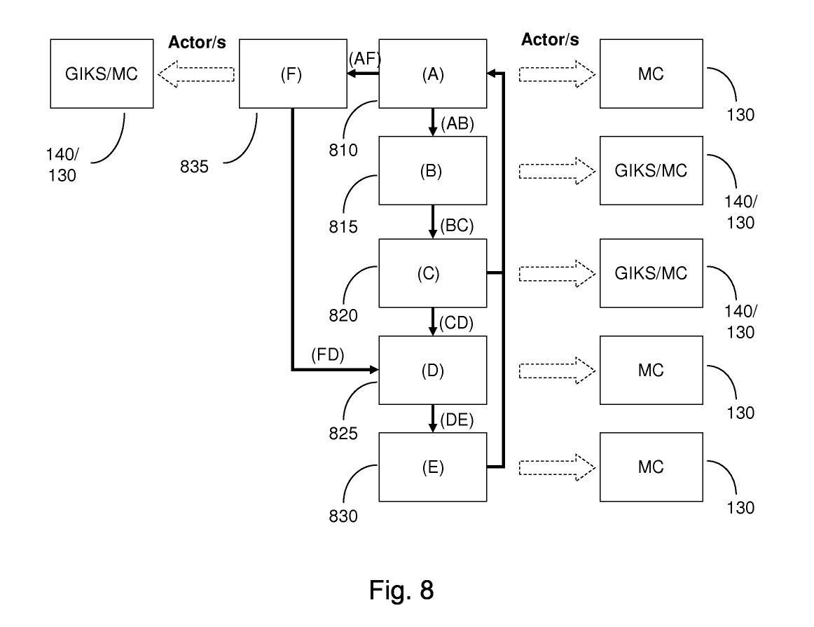

FIG. 8 is a functional block diagram for a media transmission system where context information is employed. Block A 810 may be responsible for determining the current context of the mobile. The current context may be obtained by any multilateration or positioning methods available, e.g. using GPS positioning electronics and/or software or network-based positioning electronics and/or software. The current context (AB/AF) may then be forwarded to block B 815, if the streaming scenario is applied. The current context may also be forwarded to block F 835. Block A 810 may also be responsible for logging the current transmission conditions, or this may be carried out in another block.

In FIG. 8, block F 835 may be used in the broadcast download case wherein, based on the current context, it may determine which of the media segments are lost before tune-in. If it is determined that there may be media segments that are lost before tune in, block F 835 may identify the range of segments that are lost and pass the information (FD) to block D 825. Block B 815 may be responsible for obtaining the context in the future that a mobile might pass through. This future context (BC) may be passed to block C 820. Block C 820 may be responsible for estimating the reception condition for the future context that it obtains from block B 815. The future reception conditions (CD), if transmission errors are predicted, may then be passed on to block D 825. If no transmission errors are predicted, control may be returned back to block A 810.

In FIG. 8, the input for block D 825 may be obtained from block F 835, or block C 820, or both. The function of block D 825 may be to tune in to those channels that may carry the parity bytes of lost media data. In case of future transmission errors, the parity bytes of lost media segments may be collected from their respective logical channels before the actual media data arrives. In the broadcast download case, the parity data for media lost prior to tune-in may also be available and may be collected immediately. This parity data (DE) is then passed on to block E 830. Block E 830 may have or may be connected to a parity byte decoder that may recovers the lost data based on the parity bytes that are collected in block D 825. The process control may be iteratively passed from block A 810 until block E 830. The output from blocks A, B, C, D, E and F may be made available for the various devices described earlier, e.g. the GIKS 140 and the user terminal 130.

The different example embodiments may provide several advantages. The context adaptive error resiliency may be able protect data for longer transmission error durations than some conventional ways of protection using forward error correction. This advantage may be provided by systems and devices presented in FIGS. 1a, 1b and 2. This advantage may be provided by the embodiments and their variations presented in the flow charts of methods in FIGS. 3 and 4 and by embodiments presented in the block diagram of FIG. 8. This advantage may also be apparent from FIGS. 5, 6 and 7 displaying the transmission of data from sender to receiver. In a broadcast streaming case, the parity bytes may be available beforehand, and tune-in delay may be smaller than in some conventional methods. This advantage may be provided by systems and devices presented in FIGS. 1a, 1b and 2. This advantage may be provided by the embodiments and their variations presented in the flow charts of methods in FIGS. 3 and 4 and by embodiments presented in the block diagram of FIG. 8. This advantage may also be apparent from FIGS. 5, 6 and 7 displaying the transmission of data from sender to receiver. The clients may receive only as much data as is required, reducing the client processing load and therefore reducing power consumption. This advantage may be provided by systems and devices presented in FIGS. 1a, 1b and 2. This advantage may be provided by the embodiments and their variations presented in the flow charts of methods in FIGS. 3 and 4 and by embodiments presented in the block diagram of FIG. 8. This advantage may also be apparent from FIGS. 5, 6 and 7 displaying the transmission of data from sender to receiver. The different embodiments may also used for media protection for heterogeneous receivers, and scalable media streams that support heterogeneous receivers. Unequal error protection may be used with appropriate logical channel and FEC code-rate allocation. This advantage may be provided by systems and devices presented in FIGS. 1a, 1b and 2. This advantage may be provided by the embodiments and their variations presented in the flow charts of methods in FIGS. 3 and 4 and by embodiments presented in the block diagram of FIG. 8.

The various embodiments of the invention can be implemented with the help of computer program code that resides in a memory and causes the relevant apparatuses to carry out the invention. For example, a terminal device may comprise circuitry and electronics for handling, receiving and transmitting data, computer program code in a memory, and a processor that, when running the computer program code, causes the terminal device to carry out the features of an embodiment. Yet further, a network device may comprise circuitry and electronics for handling, receiving and transmitting data, computer program code in a memory, and a processor that, when running the computer program code, causes the network device to carry out the features of an embodiment.

It is obvious that the present invention is not limited solely to the above-presented embodiments, but it can be modified within the scope of the appended claims.

1-47. (canceled)

48. A method for media transmission by an apparatus, comprising:
electronically generating error-protection information for media stream,
electronically arranging the media data to be accessible to another apparatus over a communication interface for a duration, and
electronically arranging the error-protection information to be accessible to the other apparatus over a communication interface for a duration longer than the accessibility duration of the media data.

49. A method according to claim 48, further comprising at least one of:
arranging the error-protection information to be accessible to the other apparatus over a communication interface at least partially earlier than the media data is accessible to the other apparatus over a communication interface, and
arranging the error-protection information to be accessible to the other apparatus over a communication interface at least partially later than the media data is accessible to the other apparatus over a communication interface.

50. A method according to claim 48, wherein arranging the media data and the error-protection data to be available to the other apparatus over a communication interface comprises transmitting data, and wherein the media data being arranged for transmission according to a broadcasting scheme or a data download scheme.

51. A method according to claim 48, further comprising:
partitioning the media data into a number of partitions,
arranging a media data partition to be available to the other apparatus over a media channel,
electronically generating error-protection information for the media data partition, and
arranging the error-protection information for the media data partition to be available to the other apparatus over a channel different from the media channel.

52. A method according to claim 48, wherein the communication interface is an interface to one of a physical channel and a logical channel.

53. A method for media reception by an apparatus, comprising:
electronically determining context information for the apparatus,
identifying at least one segment of error-protection information corresponding to at least one segment of media data for accessing by the apparatus based on the context information, and
accessing the identified at least one segment of error-protection information corresponding to the at least one segment of media data from a communication interface.

54. A method according to claim 53, further comprising at least one of:
using the accessed at least one segment of error-protection information to help in recovering from an error in the media data;
identifying media reception quality associated with a location using the context information;
predicting a period of time that the apparatus would be in the location;
identifying at least one segment of error-protection information based on the predicted period of time;
identifying at least one media data segment sent that has been missed to identify the at least one segment; and
accessing the error-protection information at least one of at least partially earlier and at least partially later than the corresponding segments of media data are accessible.

55. A method according to claim 53, wherein the context information comprises at least one of information on physical position or geographical location, direction of motion, speed, time, reception quality statistics associated with a geographical location and network capabilities at the location of the end-user device.

56. A method according to claim 53, wherein determining the context information comprises receiving context information from at least one of a global positioning system (GPS) transmitter, a geographical information server (GIKS), and a network.

57. A method according to claim 53, further comprising:
receiving media data on a media channel, and
receiving the error-protection information for the media data partition from a channel different from the media channel.

58. A method according to claim 53, wherein accessing the identified at least one segment of error-protection information comprises identifying a channel, and wherein said channel comprises one of a physical channel and a logical channel.

59. A method according to claim 53, further comprising:
using the error-protection information to recover media data from one or more errors, and
rendering the media data to a user.

60. A method according to claim 53, wherein the error-protection information is at least one of the group of forward error correcting information and redundant coding.

61. An apparatus comprising at least one processor, memory including computer program code, the memory and the computer program code configured to, with the at least one processor, cause the apparatus to perform at least the following:
electronically generate error-protection information for media stream,
electronically arrange the media data to be accessible to another apparatus over a communication interface for a duration, and
electronically arrange the error-protection information to be accessible to the other apparatus over a communication interface for a duration longer than the accessibility duration of the media data.

62. An apparatus according to claim 61, further comprising computer program code configured to, with the at least one processor, cause the apparatus to perform at least one of the following:
arrange the error-protection information to be accessible to the other apparatus over a communication interface at least partially earlier than the media data is accessible to the other apparatus over a communication interface; and
arrange the error-protection information to be accessible to the other apparatus over a communication interface at least partially later than the media data is accessible to the other apparatus over a communication interface.

63. An apparatus according to claim 61, wherein arranging the media data and the error-protection data to be available to the other apparatus over a communication interface comprises transmitting data, and wherein the media data being arranged for transmission according to a broadcasting scheme or a data download scheme.

64. An apparatus according to claim 61, further comprising computer program code configured to, with the at least one processor, cause the apparatus to perform at least the following:
partition the media data into a number of partitions,
arrange a media data partition to be available to the other apparatus over a media channel,
electronically generate error-protection information for the media data partition, and
arrange the error-protection information for the media data partition to be available to the other apparatus over a channel different from the media channel.

65. An apparatus according to claim 61, wherein the communication interface is an interface to one of a physical channel and a logical channel.

66. An apparatus according to claim 61, wherein the context information is information on physical position or geographical location.

67. An apparatus comprising at least one processor, memory including computer program code, the memory and the computer program code configured to, with the at least one processor, cause the apparatus to perform at least the following:
electronically determine context information for the apparatus,
identify at least one segment of error-protection information corresponding to at least one segment of media data for accessing by the apparatus based on the context information, and
access the identified at least one segment of error-protection information corresponding to the at least one segment of media data from a communication interface.

68. An apparatus according to claim 67, further comprising computer program code configured to, with the at least one processor, cause the apparatus to perform at least one of the following:
use the accessed at least one segment of error-protection information to help in recovering from an error in the media data;
identify media reception quality associated with a location using the context information;
predict a period of time that the apparatus would be in the location;
identify at least one segment of error-protection information based on the predicted period of time; and
identify at least one media data segment sent that has been missed to identify the at least one segment.

69. An apparatus according to claim 67, wherein the context information comprises at least one of information on physical position or geographical location, direction of motion, speed, time, reception quality statistics associated with a geographical location and network capabilities at the location of the end-user device.

70. An apparatus according to claim 67, wherein determining the context information comprises receiving context information from at least one of a global positioning a system (GPS) transmitter, a geographical information server (GIKS), and a network.

71. An apparatus according to claim 67, further comprising computer program code configured to, with the at least one processor, cause the apparatus to perform at least the following:
receive media data on a media channel, and
receive the error-protection information for the media data partition from a channel different from the media channel.

72. An apparatus according to claim 67, wherein accessing the identified at least one segment of error-protection information comprises identifying a channel, and wherein the channel comprises one of a physical channel and a logical channel.

73. An apparatus according to claim 67, further comprising computer program code configured to, with the at least one processor, cause the apparatus to perform at least the following:
use the error-protection information to recover media data from one or more errors, and
render the media data to a user.

74. An apparatus according to claim 67, the apparatus further comprising user interface circuitry for receiving user input, user interface software configured to facilitate user control of at least some functions of the apparatus through use of a display and configured to respond to user inputs, and a display and display circuitry configured to display at least a portion of a user interface of the apparatus, the display and display circuitry configured to facilitate user control of at least some functions of the apparatus.

75. A computer readable medium storing a computer program product, the computer program product comprising computer executable code sections when executed in a data processing cause an apparatus to perform the method according to claim 48.

76. A computer readable medium storing a computer program product, the computer program product comprising computer executable code sections when executed in a data processing cause an apparatus to perform the method according to claim 53.
